(19) United States
(12) Patent Application Publication
(10) Pub. No.: US 2026/0352266 A1
(43) Pub. Date: Nov. 5, 2026

(54) MONOSTATIC BEAM CALIBRATION FOR COMMUNICATION VIA A REFLECTIVE INTELLIGENT SURFACE

(71) Applicant: Telefonaktiebolaget LM Ericsson (publ), Stockholm (SE)

(72) Inventors: Magnus ÅSTRÖM, Lund (SE); Muris SARAJLIC, Malmö (SE); Joao VIEIRA, Hjärup (SE)

(21) Appl. No.: 19/140,079

(22) PCT Filed: Dec. 19, 2022
(86) PCT No.: PCT/EP2022/086587

§ 371 Date: Jun. 17, 2025

(51) Int. Cl. H04B 7/04; H04B 7/06

(52) U.S. Cl. CPC H04B 7/04013; H04B 7/06952

(57) ABSTRACT

There is provided techniques for monostatic beam calibration for a link between a network node and a UE via an RIS. A method is performed by the Configure RIS network node. The method comprises selecting a combination beam and a reflection state by performing monostatic beam calibration with the RIS for the link between the network node and the RIS for different combinations of beams and reflection states. The method comprises receiving a report of monostatic beam calibration as Configure UE performed by the UE for the link between the UE and the RIS. The report identifies a reflection state. The method comprises configuring the RIS with a reflection state as determined from a combination of the selected reflection state and the reported reflection state.

### TECHNICAL FIELD

Embodiments presented herein relate to a method, a network node, a computer program, and a computer program product for monostatic beam calibration for a link between the network node and a user equipment via a reflective intelligent surface. Embodiments presented herein further relate to a method, a user equipment, a computer program, and a computer program product for monostatic beam calibration for a link between the user equipment and the reflective intelligent surface.

### BACKGROUND

Reconfigurable intelligent surfaces (RISs) offer an opportunity for improved wireless communication. Specifically, significant gains are envisioned to be made for millimeter wave spectrum, which is the spectrum used in fifth generation New Radio (5G NR) and sixth generation (6G) telecommunication systems. This spectrum has some challenges when it comes to propagation and coverage, e.g., due to operating at very high frequency ranges in tens of GHz. The challenges are larger compared to challenges for spectrum with lower frequencies e.g., for so-called sub-6GHZ frequency bands.

Usage of RIS can vary, but in general an RIS can be configured to reflect wireless signals in a controlled manner, e.g., to steer transmitted signals in a certain direction. This could for example be used to improve overall system coverage, range, and efficiency. RISs are commonly also referred to as large intelligent surfaces, smart reflect-arrays, intelligent reflecting surfaces, passive intelligent mirrors, artificial radio space, and meta-surfaces.

In short, the RIS at its surface comprises an antenna array having multiple (e.g., hundreds or thousands) of antenna elements, or just elements for short. Each element can be individually configured, or controlled, to dynamically adjust the reflecting properties of the surface. The elements are provided rather to modify the properties of a signal by its reflection. The RIS commonly comprises a controller that is configured to transmit control signals to tune the properties of each element in the RIS. One example of this is disclosed in A. Araghi et al., “Reconfigurable Intelligent Surface (RIS) in the Sub-6 GHz Band: Design, Implementation, and Real-World Demonstration,” in IEEE Access, vol. 10, pp. 2646-2655, 2022, doi: 10.1109/ACCESS.2022.3140278. The RIS is thus not transmitting or receiving signals by itself but instead acts as a controllable reflector of signals transmitted and received by other nodes in the system.

In general terms, at high frequencies the propagation properties of the radio channel are more challenging and beamforming both at the network node at the network-side and at the UEs at the user-side might be required to reach a sufficient link budget. Narrow beam transmission and reception schemes might be needed at such high frequencies to compensate the expected high propagation loss. For a given communication link, a respective beam can be applied at both the network-end (as represented by the network node) and at the user-end (as represented by the UE), which typically is referred to as a beam pair link (BPL). One task of the beam management procedure is to discover and maintain beam pair links. A BPL (i.e. both the beam used by the network node and the beam used by the UE) is expected to be discovered and monitored by the network using measurements on downlink reference signals, such as channel state information reference signals (CSI-RS) or synchronization signal block (SSB) signals, used for beam management. The reference signals for beam management can be transmitted periodically, semi-persistently or a-periodically (e.g., event triggered) and they can be either shared between multiple UEs or be device-specific. In order for the UE to find a suitable network node beam, the network node transmits the reference signal in different transmission (Tx) beams on which the UE performs measurements of a received signal quality metric, such as reference signal received power (RSRP), and reports back the N best Tx beams (where N can be configured by the network). Furthermore, the transmission of the reference signal on a given Tx beam can be repeated to allow the UE to evaluate a suitable reception (Rx) beam.

One challenge with respect to straightforward extensions of the above disclosed beam management procedure in the presence of an RIS is the overall signaling overhead associated with finding the combination of transmit (Tx) beam at the network node, the reflection state at RIS, and the receive (Rx) beam at the UE during the beam training.

In further detail, focusing on the downlink (DL) scenario and assuming that the network node has M₁ Tx beams to select from, that the RIS has M₂ reflection states to select from, and that the UE has M₃ Rx beams to select from, the beam training comprises the following. For each of the M₁M₂M₃ combinations of {network node Tx beam, RIS reflection state, UE beam}, the network node will send a DL reference signal (RS). For each such DL RS transmission, the UE will measure the signal quality. When all/some DL RS transmissions are finalized, the UE will report at least a subset of the measurements back to the network node. The combination of {network node Tx beam, RIS reflection state, UE Rx beam} with the best Rx signal quality will be selected for implementing the NN-RIS-UE link (where NN is short for network node).

This will consume M₁M₂M₃ DL time-frequency resources in the worst case. This could be an issue if dedicated DL RSs are used (as opposed to using RS common to all UEs in the cell, such as synchronization signal block (SSB) type RS). For a large enough number of UEs and/or in conditions with highly mobile UEs having their network access supported by an RIS, the associated overhead may prove to be too large for the beam training procedure to be carried out.

The overhead can be reduced by using RS common to all UEs in the cell. However, such RS are sent in beams that are made wider than beams used for RS dedicated to one UE in the cell. This results in poorer coverage than if using beams that are dedicated to one UE which can be made as narrow as desired.

Moreover, the limited periodicity of the RS common to all UEs may incur significant latency if all M₁M₂M₃ combinations are to be tested.

Hence, there is still a need for an improved management procedure in the presence of an RIS.

### SUMMARY

An object of embodiments herein is to provide a beam management process, suitable for communication systems in which a RIS is present, that does not suffer from the above disclosed issues.

According to a first aspect there is presented a network node for monostatic beam calibration for a link between the network node and a UE via an RIS. The network node is configured for communication in a first set of beams. The UE is configured for communication in a second set of beams. The RIS is configured for communication in a set of reflection states as controllable by the network node. The network node comprises processing circuitry. The processing circuitry is configured to cause the network node to select a combination of one beam in the first set of beams and a first reflection state in the reflection states by performing monostatic beam calibration with the RIS for the link between the network node and the RIS for different combinations of beams in the first set of beams and reflection states in the set of reflection states. The processing circuitry is configured to cause the network node to receive a report of monostatic beam calibration as performed by the UE for the link between the UE and the RIS. The report identifies a second reflection state in the reflection states. The processing circuitry is configured to cause the network node to configure the RIS with a third reflection state as determined from a combination of the first reflection state and the second reflection state.

According to a second aspect there is presented a network node for monostatic beam calibration for a link between the network node and a UE via an RIS. The network node is configured for communication in a first set of beams. The UE is configured for communication in a second set of beams. The RIS is configured for communication in a set of reflection states as controllable by the network node. The network node comprises a select module configured to select a combination of one beam in the first set of beams and a first reflection state in the reflection states by performing monostatic beam calibration with the RIS for the link between the network node and the RIS for different combinations of beams in the first set of beams and reflection states in the set of reflection states. The network node comprises a receive module configured to receive a report of monostatic beam calibration as performed by the UE for the link between the UE and the RIS. The report identifies a second reflection state in the reflection states. The network node comprises a configure module configured to configure the RIS with a third reflection state as determined from a combination of the first reflection state and the second reflection state.

According to a third aspect there is presented a method for monostatic beam calibration for a link between a network node and a UE via an RIS. The network node is configured for communication in a first set of beams. The UE is configured for communication in a second set of beams. The RIS is configured for communication in a set of reflection states as controllable by the network node. The method is performed by the network node. The method comprises selecting a combination of one beam in the first set of beams and a first reflection state in the reflection states by performing monostatic beam calibration with the RIS for the link between the network node and the RIS for different combinations of beams in the first set of beams and reflection states in the set of reflection states. The method comprises receiving a report of monostatic beam calibration as performed by the UE for the link between the UE and the RIS. The report identifies a second reflection state in the reflection states. The method comprises configuring the RIS with a third reflection state as determined from a combination of the first reflection state and the second reflection state.

According to a fourth aspect there is presented a computer program for monostatic beam calibration for a link between a network node and a UE via an RIS. The computer program comprises computer code which, when run on processing circuitry of a network node, causes the network node to perform actions. One action comprises the network node to select a combination of one beam in the first set of beams and a first reflection state in the reflection states by performing monostatic beam calibration with the RIS for the link between the network node and the RIS for different combinations of beams in the first set of beams and reflection states in the set of reflection states. One action comprises the network node to receive a report of monostatic beam calibration as performed by the UE for the link between the UE and the RIS. The report identifies a second reflection state in the reflection states. The network node comprises a configure module configured to configure the RIS with a third reflection state as determined from a combination of the first reflection state and the second reflection state.

According to a fifth aspect there is presented a UE for monostatic beam calibration for a link between the UE and an RIS. The UE is configured for communication in a second set of beams with a network node via the RIS. The RIS is configured for communication in a set of reflection states. The UE comprises processing circuitry. The processing circuitry is configured to cause the UE to select a combination of one beam in the second set of beams and a second reflection state in the reflection states by performing monostatic beam calibration with the RIS for the link between the UE and the RIS for different combinations of beams in the second set of beams and reflection states in the set of reflection states. The processing circuitry is configured to cause the UE to send a report of the monostatic beam calibration towards the network node. The report identifies the second reflection state.

According to a sixth aspect there is presented a user equipment, UE for monostatic beam calibration for a link between the UE and an RIS. The UE is configured for communication in a second set of beams with a network node via the RIS. The RIS is configured for communication in a set of reflection states. The UE comprises a select module configured to select a combination of one beam in the second set of beams and a second reflection state in the reflection states by performing monostatic beam calibration with the RIS for the link between the UE and the RIS for different combinations of beams in the second set of beams and reflection states in the set of reflection states. The UE comprises a send module configured to send a report of the monostatic beam calibration towards the network node. The report identifies the second reflection state.

According to a seventh aspect there is presented a method for monostatic beam calibration for a link between a UE and an RIS. The UE is configured for communication in a second set of beams with a network node via the RIS. The RIS is configured for communication in a set of reflection states. The method is performed by the UE. The method comprises selecting a combination of one beam in the second set of beams and a second reflection state in the reflection states by performing monostatic beam calibration with the RIS for the link between the UE and the RIS for different combinations of beams in the second set of beams and reflection states in the set of reflection states. The method comprises sending a report of the monostatic beam calibration towards the network node. The report identifies the second reflection state.

According to an eighth aspect there is presented a computer program for monostatic beam calibration for a link between a UE and an RIS. The computer program comprises computer code which, when run on processing circuitry of a UE, causes the UE to perform actions. One action comprises the UE to select a combination of one beam in the second set of beams and a second reflection state in the reflection states by performing monostatic beam calibration with the RIS for the link between the UE and the RIS for different combinations of beams in the second set of beams and reflection states in the set of reflection states. One action comprises the UE to send a report of the monostatic beam calibration towards the network node. The report identifies the second reflection state.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide a beam management process which is suitable for communication systems in which a RIS is present, and which does not suffer from the above disclosed issues.

Advantageously, these aspects enable the network node to determine its best beam to reach the RIS, and the UE to determine its best beam to reach the RIS.

Advantageously, these aspects enable the UE to, through use of monostatic sensing, find the best beam towards the RIS independently of the network node and without relying on any DL signals from the network node. Thus, no DL RSs are needed for establishing of the RIS-UE part of the link. The network DL resources that would have been used for this purpose can therefore be used for e.g. serving other UEs. Advantageously, these aspects enable the overhead to be significantly reduced compared to the beam training procedure described above. In further detail, the total number of measurements in the procedure is M₁M₂+M₂M₃=M₂(M₁+M₃) which is significantly less than M₁M₂M₃ measurements needed using a straightforward extension of the beam training procedure described above. Here, M₁M₂ measurements are needed for establishing the NN-RIS part of the link (assuming that Tx and Rx beams at the network node are the same) and M₂M₃ measurements are needed for establishing the RIS-UE part of the link (assuming Tx and Rx beam reciprocity at the UE).

As a consequence of the significantly smaller number of needed measurements, the beam training can be performed in a much shorter time than the procedure based on 5G NR beam training procedures, indicating significantly reduced latency.

Advantageously, these aspects enable the NN-RIS link and the RIS-UE link to be trained in parallel, which will reduce the latency even further.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to embodiments;

FIGS. 2 and 3 are flowcharts of methods according to embodiments;

FIG. 4 is a schematic illustration of determination of a joint reflection state according to embodiments;

FIG. 5 is a schematic illustration of mapping of reflection states to symbols and slots for monostatic beam calibration as performed by a network node according to embodiments;

FIG. 6 is a schematic illustration of mapping of reflection states to symbols and slots for monostatic beam calibration as performed by a UE according to embodiments;

FIG. 7 is a signaling diagram of a method according to an embodiment;

FIG. 8 is a schematic diagram showing functional units of a network node according to an embodiment;

FIG. 9 is a schematic diagram showing functional modules of a network node according to an embodiment;

FIG. 10 is a schematic diagram showing functional units of a UE according to an embodiment;

FIG. 11 is a schematic diagram showing functional modules of a UE according to an embodiment; and

FIG. 12 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

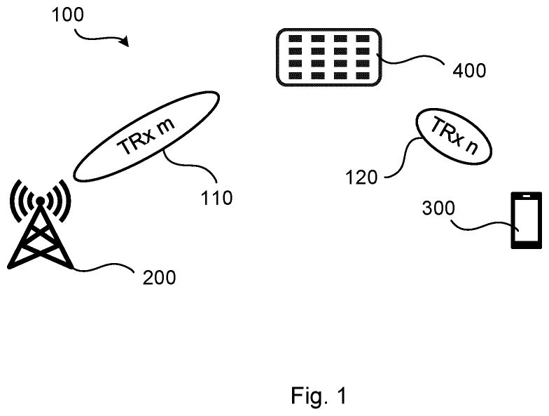

FIG. 1 is a schematic diagram illustrating a communication system 100 where embodiments presented herein can be applied. In the communication system 100 a network node 200 is configured to provide network access to a UE 300. The network node 200 might be any of a radio access network node, radio base station, base transceiver station, node B (NB), evolved node B (eNB), gNB, access point, access node, integrated access and backhaul node. The UE 300 might be any of a portable wireless device, mobile station, mobile phone, handset, wireless local loop phone, smartphone, laptop computer, tablet computer, wireless modem, wireless sensor device, Internet of Things device, network equipped vehicle. Signals communicated over wireless links between the network node 200 and the UE 300 are reflected via a reflective array of a RIS 400. More particularly, the reflective array is composed of antenna arrays, and the signals are reflected according to reflection phases of the antenna elements. The reflection phases are controlled, or set, by a controller provided in the RIS 400. The purpose of the controller is thus to control how incoming signals are steered or simply reflected at the RIS 400. For this purpose, according to published technology, the controller may have a signaling connection (wired or wireless) with the network node 200. The network node 200 then needs to know how to configure the RIS 400 to optimize the end-to-end link using the reflections from the RIS 400. As will be further disclosed below, in order to evaluate different RIS configurations, the network node 200 may request the controller to facilitate a sweep, or switch, between different configurations of the elements in the RIS 400 whilst the network node 200 and the UE 300 transmit and receive signals for analysis of suitable configurations of the elements in the reflective array of the RIS 400 and for selecting which beams, as in FIG. 1 represented by the beams 110, 120 denoted “TRx m” and “TRx n” respectively, to be used for communication between the network node 200 and the UE 300.

The embodiments disclosed herein relate to techniques for monostatic beam calibration for a link between a network node 200 and a UE 300 via an RIS 400 and techniques for monostatic beam calibration for a link between a UE 300 and an RIS 400. In order to obtain such techniques, there is provided a network node 200, a method performed by the network node 200, a computer program product comprising code, for example in the form of a computer program, that when run on processing circuitry of the network node 200, causes the network node 200 to perform the method. In order to obtain such techniques, there is further provided a UE 300, a method performed by the UE 300, and a computer program product comprising code, for example in the form of a computer program, that when run on processing circuitry of the UE 300, causes the UE 300 to perform the method.

According to at least some of the herein disclosed embodiments, directional training of the NN-RIS UE link is performed using monostatic beam calibration independently by the network node 200 and the UE 300, respectively.

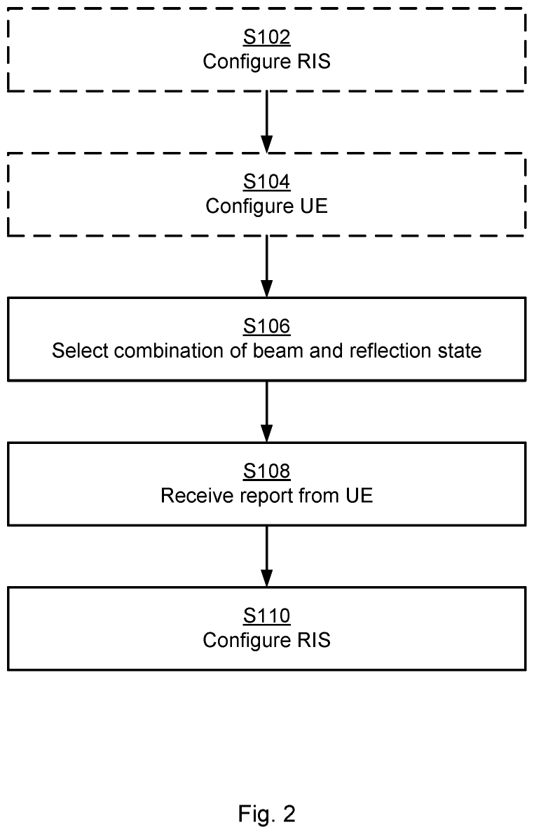

Reference is now made to FIG. 2 illustrating a method for monostatic beam calibration for a link between a network node 200 and a UE 300 via an RIS 400 as performed by the network node 200 according to an embodiment. The network node 200 is configured for communication in a first set of beams. The UE 300 is configured for communication in a second set of beams. The RIS 400 is configured for communication in a set of reflection states as controllable by the network node 200.

In general terms, the best beam from the network node 200 towards the RIS might be found by the network node 200 repeatedly transmitting a sensing signal M₂ times in each of the candidate Tx beams. For each of the M₂ transmissions of the sensing signal in a particular Tx beam, the RIS will have a different reflection state. For one, or just a few, of the combinations of {Tx beam, RIS reflection state} , the sensing signal as reflected back to the network node 200 from the RIS will illuminate the network node 200 itself. Since the network node 200 is receiving at the same time as it is transmitting in a given beam, the network node 200 will thus know in which beam the sensing signal that was reflected back to the network node 200 was transmitted. It is here noted that the network node 200 might also occasionally, depending on the physical environment in which the network node 200 is deployed, receive reflections also from the objects in the environment and not only from the RIS. However, it is assumed that the reflection from the RIS will a) likely be much stronger than ambient reflections and b) come at a time when a change in RIS reflection state is expected (as the RIS is network-controlled and time-synchronized with the network node 200). Therefore, the network node 200 will know with significant certainty that the reflection came from the RIS and not from an object in the environment.

S106: The network node 200 selects a combination of one beam in the first set of beams and a first reflection state in the reflection states by performing monostatic beam calibration with the RIS for the link between the network node 200 and the RIS 400 for different combinations of beams in the first set of beams and reflection states in the set of reflection states.

Hence, the network node 200 finds a suitable Tx beam and associated RIS reflection state that generates a suitable link NN-RIS(-NN) by means of monostatic sensing. The network node 200 will store the best beam and the corresponding RIS reflection state, denoted S_{NN-RIS}.

S108: The network node 200 receives a report of monostatic beam calibration as performed by the UE 300 for the link between the UE 300 and the RIS 400. The report identifies a second reflection state in the reflection states.

S110: The network node 200 configures the RIS 400 with a third reflection state as determined from a combination of the first reflection state and the second reflection state.

The RIS 400 is thereby configured according to the reflection pattern associated with the third reflection state in order to enable communication between the network node 200 and the UE 300 via the RIS 400.

Embodiments relating to further details of monostatic beam calibration for a link between a network node 200 and a UE 300 via an RIS 400 as performed by the network node 200 will now be disclosed with continued reference to FIG. 2.

In general terms, one goal, after establishing NN-RIS and UE-RIS links, is to find a suitable RIS configuration state, herein referred to as a third reflection state, that allows a robust link NN-RIS-UE. Here, the network node 200 uses the beam determined in the monostatic sensing procedure in step S106 and the UE 300 uses the beam resulting from the selection made in below described step S206.

In some embodiments, each of the reflection states represent a respective set of phase shift settings associated with individual elements of the RIS 400, where the third reflection state is determined as a function of the set of phase shift settings for the first reflection state and the set of phase shift settings for the second reflection state. In some examples, the RIS reflection pattern associated with the third configuration state is the average of the reflection patterns associated with the reflection states S_{NN-RIS} and S_{UE-RIS}. For example, if the reflection pattern associated with the reflection state S_{NN-RIS} applies a linear phase shift across neighboring reflecting elements of the RIS by 10 degrees, and the reflection pattern associated with the reflection state S_{UE-RIS} applies a linear phase shift across neighboring reflecting elements of the RIS by 50 degrees, the reflection pattern associated with the third configuration state should apply a linear phase shift across neighboring reflecting elements of the RIS by (50+10)/2=30 degrees.

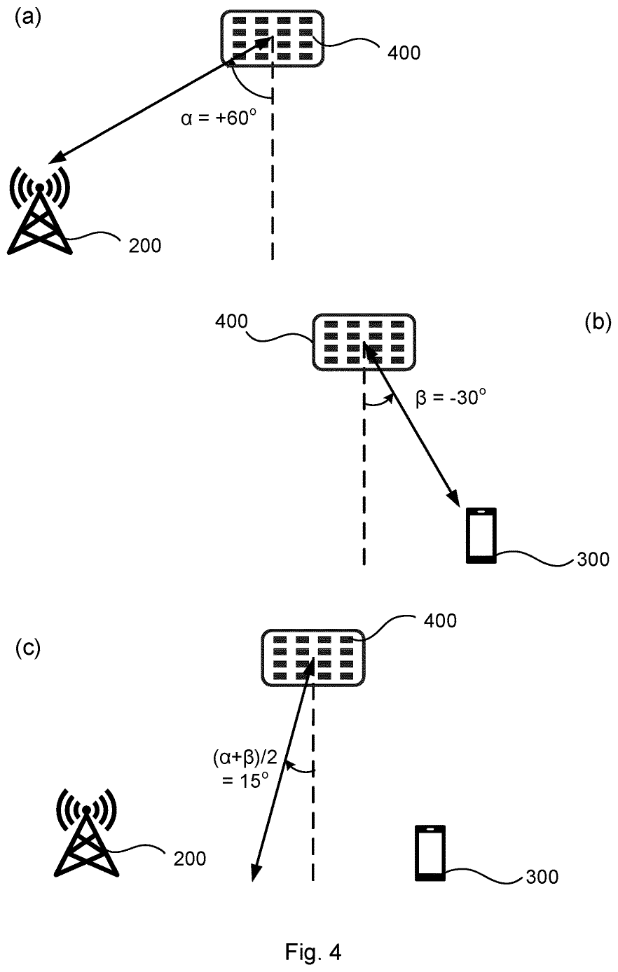

One example of how the joint reflection state might be calculated is illustrated in FIG. 4, using a line of reasoning associated with light propagation and representing the RIS 400 as a mechanically rotated mirror. In FIG. 4(a) the reflection pattern associated with the reflection state S_{NN-RIS} is determined to correspond to a linear phase shift Ad across neighboring reflecting elements of the RIS, resulting in steering angle of +45 degrees. In FIG. 4(b) the reflection pattern associated with the reflection state S_{UE-RIS} is determined to correspond to a linear phase shift-Ad across neighboring reflecting elements of the RIS, resulting in steering angle of-45 degrees. Therefore, as in FIG. 4(c), the reflection pattern associated with the third configuration state should apply a linear phase shift across neighboring reflecting elements of the RIS by (Δφ+(−Δφ))/2 =0 degrees.

Disregarding diffraction, it can be assumed that the reflected light wave will be scattered evenly in all directions in the half-space determined by the reflecting side of the rotated mirror. Analogously, electro-mechanical waves reflecting from the RIS 400 will be evenly scattered in the half-space determined by the phase shift over RIS elements. If the network node 200 can see itself in the mirror when the mirror is rotated by α degrees (analogous considerations applies to electro-mechanical propagation and electronic phase rotation performed by the RIS 400) and the UE 300 can see itself in the mirror when the mirror is rotated by β degrees, the network node 200 will see the UE 300 in the mirror 400 (and vice versa) when the mirror is rotated by (α+β)/2 degrees.

Further aspects of the monostatic beam calibration will be disclosed next.

In general terms, the RIS 400 is assumed to be time-synchronized to, and controllable by, the network node 400. Further, in some aspects the RIS 400 is scheduled by the network node 200 to cycle through a set of reflection states in a time-sequential manner at certain time instances, and possibly also frequency resources, depending on the RIS spectral properties. Hence, in some embodiments, the network node 200 is configured to perform (optional) step S102.

S102: The network node 200 configures the RIS 400 with the set of reflection states and instructions to cycle through the set of reflection states in a time synchronized and time-sequential manner.

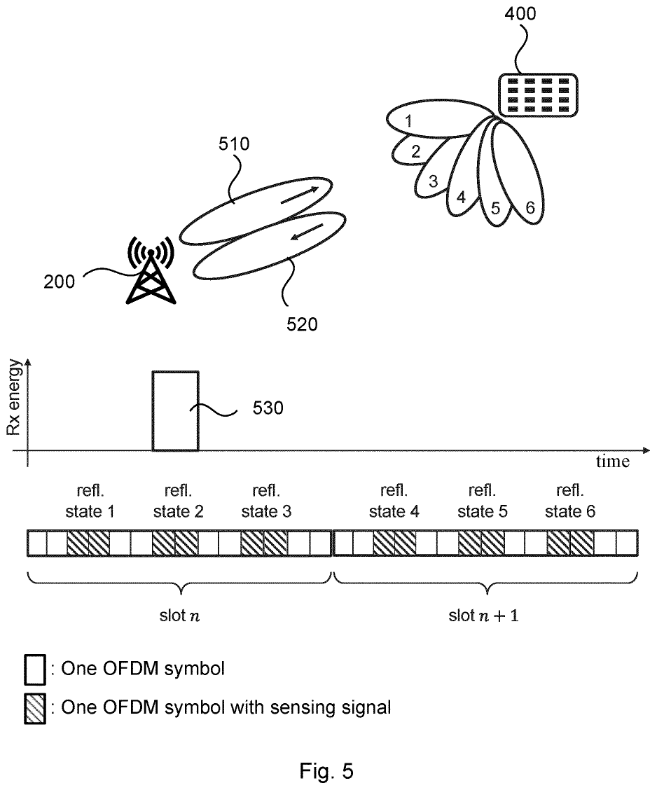

As an illustrative, non-limiting, example, assume that the RIS 400 has 6 reflection states, and each state is applied for the duration of 2 OFDM symbols in an NR slot, with the mapping of reflection states to symbols and slots illustrated in FIG. 5. In each of the time instances corresponding to the reflection states, the network node 200, as part of performing the monostatic beam calibration with the RIS 400, transmits a sensing signal in a Tx beam 510 and simultaneously performs reception using an Rx beam 520. The sending of sensing signals is synchronized in time with the scheduling of the reflection states. In some examples, one sensing signal is sent during the two OFDM symbols for which one reflection state is applied. In other examples, one sensing signal is sent for each of the OFDM symbols in the two-symbol group. Hence, in some embodiments, according to the monostatic beam calibration, a sensing signal is transmitted by the network node 200 for reflection by the RIS 400 back to the network node 200 for each combination of beams in the first set of beams and reflection states in the set of reflection states. For the example in FIG. 5, there will be 12 received sensing signals resulting from the monostatic sensing procedure for a given Tx/Rx beam, i.e. 2 received sensing signals per each of the 6 reflection states, if one sensing signal is sent in each of the OFDM symbols in the group of 2 OFDM symbols.

Transmission and reception might be performed in the same frequency band and thus there is risk of transmitter-to-receiver leakage at the network node 200 as a reflection might arrive before the transmission is over. However, with careful design of the sensing signal (such as using ultra-short pulses) this situation may be avoided. With regards to the example in FIG. 5, using shorter sensing signals would imply sending the sensing signal across 1 OFDM symbol rather than 2 OFDM symbols.

For a Tx beam that is not directed towards the RIS 400, the sensing signal will either reflect from objects in the environment and those reflections will be received in the Rx beam at the network node 200, or the sensing signal will not reflect from objects in the environment and the eventual reflections will not be received in the Rx beam at the network node 200. In other words, regardless of RIS configuration, the Tx beam that is not directed towards the RIS will result in a similar received sensing signal. Thereby, the sensing signals (e.g., 12 sensing signals in the example of FIG. 5) will present characteristics that will inform the network node 200 that the Tx beam was not illuminating the RIS. For example, a similar impulse response will be estimated from each received sensing signal of the Tx beam, or a similar energy will be measured from each received sensing signal.

On the other hand, for a Tx beam that indeed is directed towards the RIS 400, the reflection at the time instance corresponding to the reflection state that reflects the signal back to the network node 200 will be registered as a spike 530 in Rx energy, in relation to other time instances when the RIS is reflecting the Tx beam elsewhere, or as a new path in the measured impulse response. The network node 200 will then, with significant certainty, know that the reflection came from the RIS 400 and not from other scattering objects.

The process above may be repeated for a number of Tx/Rx beams. That is, in some embodiments, according to the monostatic beam calibration, the different combinations of beams in the first set of beams and reflection states in the set of reflection states are cycled through in a time synchronized and time-sequential manner whilst the sensing signals are transmitted by the network node 200.

Further, in some embodiments, the combination of beam in the first set of beams and reflection state in the reflection states is selected S106 that satisfies a performance metric for the sensing signals at the network node 200. In this respect, the Tx beam and the RIS reflection state that jointly generated a link NN-RIS with, e.g., the largest path gain (defined in terms of highest RSRP measurements, or highest reference signal received quality (RSRQ) measurements), or highest differential thereof compared to other RIS reflection states of the same Tx beam, thereby identify the Tx beam and the reflection state for implementing the NN-RIS link. In the example in FIG. 5, S_{NN-RIS} is defined by reflection state 2 (that provides largest Rx energy at the network node 200).

In some aspects, the network node 200 uses the same Tx and Rx beams for transmission and reception of the sensing signal. In other words, the radiation pattern of the beam in which the sensing signal is transmitted is approximately equal to the radiation pattern of the beam in which the sensing signal is received after reflection at the RIS 400. One advantage of this is that any received reflected sensing signals will benefit from Tx and Rx array gain, which can potentially improve the sensing performance.

In other aspects, the network node 200 does not use the same Tx and Rx beams for transmission and reception of the sensing signal. For example, the beam in which the sensing signal is transmitted may be a directive beam whereas the beam in which the sensing signal is received after reflection at the RIS 400 may be an omni-directional beam (or vice versa). One advantage of this is that it is more likely that signals travelling from different propagation path(s) NN-to-RIS and RIS-to-NN will also be detected. This increases the probability of finding a suitable Tx beam for the network node 200.

The beam steering may be further refined in that a first set of antenna elements is configured for transmission and a second set of antenna elements is configured for reception. Hence, in some embodiments, the network node 200 comprises antenna elements, and, during the monostatic beam calibration with the RIS 400, a first set of the antenna elements is used for transmission of the sensing signals and a second subset of the antenna elements is used for reception of the sensing signals. Subsequently, and in accordance with both antenna and RIS configurations, both the first antenna set and the second antenna set can be steered in the hypothesized direction towards the RIS 400. The two antenna sets might comprise, e.g., two groups of physically distinct antenna elements of an array, or to the vertical and horizontal polarizations of dual-polarized antenna elements of an array. The former approach might be regarded as an array of sub-arrays, where one of several transceiver chains is associated with a set of antenna elements of an antenna array, and where one such antenna element is associated with one and one only transceiver chain. In such a case, one such transceiver chain may be configured for Tx mode, and another such transceiver chain may be configured for Rx mode, in order to perform the sensing procedure.

In order to determine the reflection state S_{UE-RIS} between the RIS 400 and the UE 300, the network node 200 may configure (time and/or frequency) resources to be used for monostatic sensing by the UE 300 with respect to the RIS 400. Timewise, those resources may be aligned with the time instances configured for the RIS 400 to apply the reflection states. Frequency-wise, the resources might not overlap with other uplink resources in which other UEs might be scheduled to transmit, or with other downlink resources. Particularly, in some embodiments, the network node 200 is configured to perform (optional) step S104.

S104: The network node 200 configures the UE 300 to perform the monostatic beam calibration for the link between the UE 300 and the RIS 400.

Further, the configuration might pertain to properties of uplink sensing signals to be used by the UE 300, such the time/frequency instances used by the UE 300 to transmit a sensing signal, a comb structure and comb offset if applied, frequency hopping pattern if applied, etc.

Considering the sensitivity of measurements, e.g., both relatively limited transmit power at the UE 300 and relatively poor antennas at the UE 300, the resources the UE 300 are configured with might be coordinated among adjacent network nodes 200 to limit neighbor cell interference. Alternatively, or additionally, the configured resources reside in uplink slots, thereby minimizing interference. Upon finalizing the measurements, the UE provides a measurement report back to the network node, as in step S108.

In general terms, the UE 300 might by the network node 200 be configured to use the same metrics as the network node 200 when determining the preferred reflection state. That is, in some embodiments, the UE 300 is (in step S104) configured by the network node 200 to select the second reflection state as the reflection state in the reflection states that satisfies a performance metric at the UE 300 of sensing signals as transmitted by the UE 300 and reflected by the RIS 400. In this respect, the Rx beam at the UE 300 and the RIS reflection state that jointly generated a link RIS-UE with, e.g., the largest path gain (defined in terms of highest reference signal received power measurements, or highest reference signal received quality measurements), thereby identify the Rx beam at the UE 300 and the reflection state for implementing the RIS-UE link.

In some aspects, the monostatic beam calibration is initiated by the network node 200 if a performance degradation due to e.g. device movement is detected. The performance degradation can be detected e.g. based on a decrease of reported RSRP, RSRP, or an increase in the number of negative acknowledgements (NACKs) from the UE 300. Hence, in some embodiments, the monostatic beam calibration with the RIS 400 is performed responsive to the network node 200 having obtained an indication of change in received signal quality in either downlink or uplink. In some examples, the monostatic beam calibration with the RIS 400 is performed at pre-configured time instances, or regularly, or periodically.

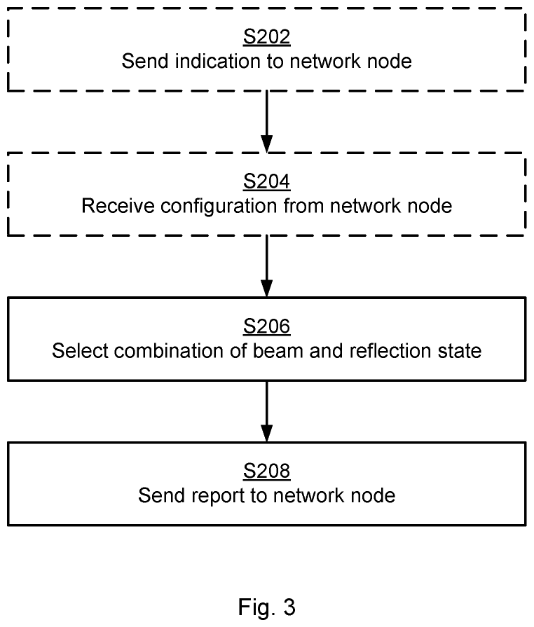

Reference is now made to FIG. 3 illustrating a method for monostatic beam calibration for a link between a UE 300 and an RIS 400 as performed by the UE 300 according to an embodiment. The UE 300 is configured for communication in a second set of beams with the network node 200 via the RIS 400. The RIS 400 is configured for communication in a set of reflection states.

In general terms, finding the best beam to use by the UE 300 when receiving signals from the network node 200 as reflected by the RIS follows the same procedure as for the network node 200 when transmitting signals towards the UE 300 via the RIS. That is, the UE 300 might repeatedly transmit M₂ repetitions of a sensing signal for each beam, where the RIS switches reflection states for each transmission from the UE 300. As both the UE 300 and the RIS are time-synchronized with the network, an implicit time synchronization of the UE 300 with the RIS is achieved.

For one, or just a few, of the combinations of {Rx beam, RIS reflection state}, the sensing signal as reflected back to the UE 300 from the RIS will illuminate the UE 300 itself. Since the UE 300 is receiving at the same time as it is transmitting in a given beam, the UE 300 will thus know in which beam the sensing signal that was reflected back to the network node 200 was transmitted. It is here noted that the UE 300 might also occasionally, depending on the physical environment in which the UE 300 is located, receive reflections also from the objects in the environment and not only from the RIS. However, it is assumed that the reflection from the RIS will a) likely be much stronger than ambient reflections and/or b) come at a time when a change in RIS reflection state is expected (as the RIS is network-controlled and time-synchronized with the UE 300) and/or c) be substantially stronger compared to the case where the RIS is reflecting the same Tx beam in a different direction. Therefore, the UE 300 will know with significant certainty that the reflection came from the RIS and not from an object in the environment.

S206: The UE 300 selects a combination of one beam in the second set of beams and a second reflection state in the reflection states by performing monostatic beam calibration with the RIS 400 for the link between the UE 300 and the RIS 400 for different combinations of beams in the second set of beams and reflection states in the set of reflection states.

Hence, the UE 300 finds a suitable beam and associated RIS reflection state that generates a suitable link (UE-) RIS-UE by means of monostatic sensing. The UE 300 will store the best beam and report the corresponding RIS reflection state, denoted S_{UE-RIS}, back to the network node 200 (which then also stores S_{UE-RIS}, as disclosed above).

S208: The UE 300 sends a report of the monostatic beam calibration towards the network node 200. The report identifies the second reflection state.

Embodiments relating to further details of monostatic beam calibration for a link between a UE 300 and an RIS 400 as performed by the UE 300 will now be disclosed with continued reference to FIG. 3.

As disclosed above, in order to determine the reflection state S_{UE-RIS} between the RIS 400 and the UE 300, the network node 200 may configure (time and/or frequency) resources to be used for monostatic sensing by the UE 300 with respect to the RIS 400. Therefore, in some embodiments, the UE 300 is configured to perform (optional) step S204.

S204: The UE 300 receives configuration from the network node 200 for the UE 300 to perform the monostatic beam calibration for the link between the UE 300 and the RIS 400.

In some embodiments, according to the monostatic beam calibration, a sensing signal is transmitted by the UE 300 for reflection by the RIS 400 back to the UE 300 for each combination of beams in the second set of beams and reflection states in the set of reflection states.

In general terms, the monostatic sensing by the UE 300 with respect to the RIS 400 follows the same procedure as the monostatic sensing by the network node 200 with respect to the RIS 400, but with an object to identify an Rx beam at the UE 300 instead of a Tx beam at the network node 200.

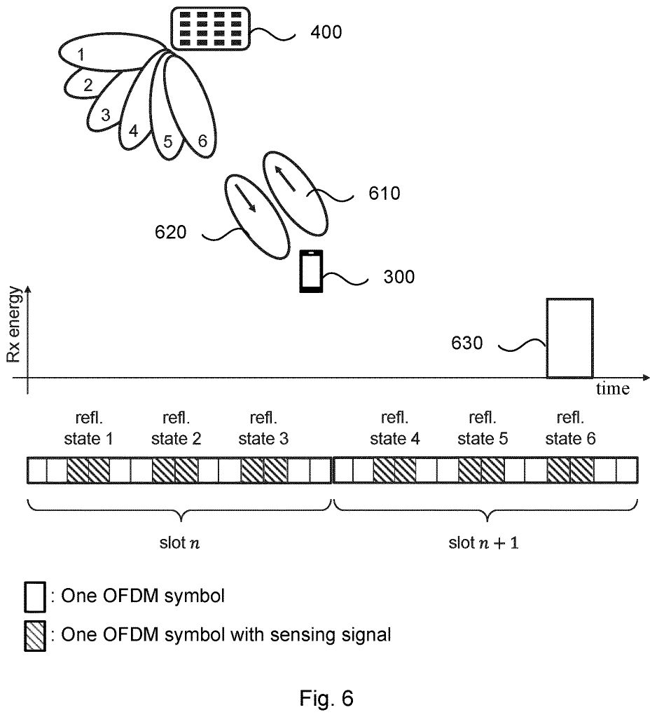

Hence, as illustrated in FIG. 6, in each of the configured resources, the UE 300 will transmit a sensing signal using a Tx beam 610 and simultaneously perform reception using an Rx beam 620 (preferably but not necessarily pointing in the same direction of the Tx beam 610, depending on if directive beams or omni-directional beams are used, in line with what has been disclosed above). That is, for an Rx beam that indeed is directed towards the RIS 400, the reflection at the time instance corresponding to the reflection state that reflects the signal back to the UE 300 will be registered as a spike 630 in Rx energy, or as a new path in the measured impulse response. The UE 300 will then, with significant certainty, know that the reflection of the sensing signal came from the RIS 400 and not from other scattering objects. In the example in FIG. 6, S_{UE-RIS} is thus defined by reflection state 6 (that provides largest Rx energy at the UE 300).

As above, the process above may be repeated for a number of Tx/Rx beams. That is, in some embodiments, according to the monostatic beam calibration, the different combinations of beams in the second set of beams and reflection states in the set of reflection states are cycled through in a time synchronized and time-sequential manner whilst the sensing signals are transmitted by the UE 300.

Further, in some embodiments, the second reflection state satisfies a performance metric for the sensing signals at the UE 300. In this respect, the Rx beam and the RIS reflection state that jointly generated a link RIS-UE with, e.g., the largest path gain (defined in terms of highest RSRP measurements, or highest RSRQ measurements), thereby identify the Rx beam and the reflection state for implementing the RIS-UE link.

As above, the beam steering may be further refined in that a first set of antenna elements is configured for transmission and a second set of antenna elements is configured for reception. Hence in some embodiments, the UE 300 comprises antenna elements, and, during the monostatic beam calibration with the RIS 400, a first set of the antenna elements is used for transmission of the sensing signals and a second subset of the antenna elements is used for reception of the sensing signals.

As above, the monostatic beam calibration with the RIS 400 might be performed responsive to the network node 200 having obtained an indication of change in received signal quality in either downlink or uplink. Therefore, in some embodiments, the UE 300 is configured to perform (optional) step S202.

S202: The UE 300 sends an indication to the network node 200 responsive to the UE 300 having obtained an indication of change of any of: received signal quality in downlink, rotation of the UE 300.

The configuration from the network node 200 for the UE 300 to perform the monostatic beam calibration is then received in response thereto, i.e., in response to the UE 300 having sent the indication in step S202.

In this respect, the UE 300 might detect a change in received signal power or quality by comparing RSRP or RSRQ values measured on downlink reference signals with some threshold value. The UE 300 may also employ side information, such as information about motion or rotation, and infer that the currently used beam towards the RIS 400 is likely to be outdated and then send an indication as in step S202.

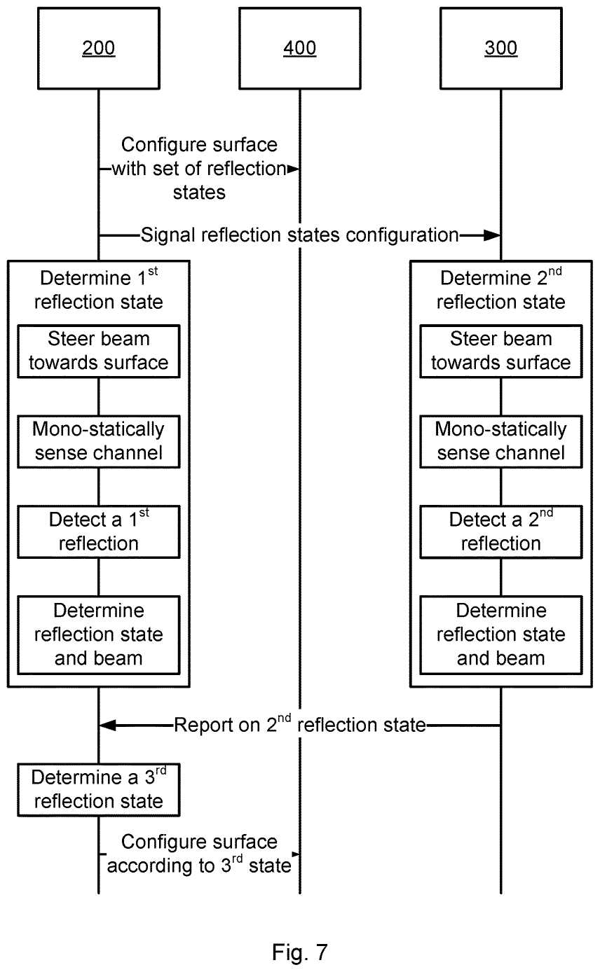

One particular embodiment for monostatic beam calibration for a link between the network node 200 and the RIS 400 and for monostatic beam calibration for a link between the UE 300 and the RIS 400 as based on at least some of the above disclosed embodiments will now be disclosed in detail with reference to the signalling diagram of FIG. 7.

S301: The network node 200 configures the RIS 400 with the set of reflection states and instructions to cycle through the set of reflection states in a time synchronized and time-sequential manner-S302: The network node 200 configures the UE 300 to perform the monostatic beam calibration for the link between the UE 300 and the RIS 400.

S303: The network node 200 performs monostatic beam calibration for a link between the network node 200 and the RIS 400. As a result thereof, the network node 200 selects a combination of one beam in the first set of beams and a first reflection state in the reflection states. The monostatic beam calibration comprises the network node 200 to steer different Tx beams and Rx beams towards the RIS 400, transmitting a sensing signal to sense the channel, detecting any possible reflection from the RIS 400 for the current Tx beam, and determining the best Tx beam and the corresponding best reflection state.

S304: The UE 300 performs monostatic beam calibration for a link between the UE 300 and the RIS 400. As a result thereof, the UE 300 selects a combination of one beam in the second set of beams and a second reflection state in the reflection states. The monostatic beam calibration comprises the UE 300 to steer different Tx beams and Rx beams towards the RIS 400, transmitting a sensing signal to sense the channel, detecting any possible reflection from the RIS 400 for the current Rx beam, and determining the best Rx beam and the corresponding best reflection state.

S305: The UE 300 sends a report of the monostatic beam calibration towards the network node 200. The report identifies the second reflection state.

S306: The network node 200 determines a third reflection state for the RIS 400 from a combination of the first reflection state and the second reflection state.

S307: the network node 200 configures the RIS 400 with the third reflection state.

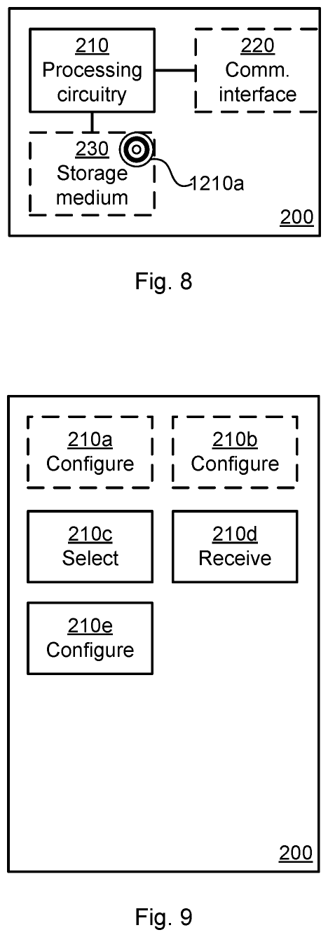

FIG. 8 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1210a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications (comm.) interface 220 for communications with other entities, functions, nodes, and devices, either directly or indirectly, such as with the UE 300 via the RIS 400. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 9 schematically illustrates, in terms of a number of functional modules, the components of a network node 200 according to an embodiment. The network node 200 of FIG. 9 comprises a number of functional modules; a select module 210c configured to perform step S106, a receive module 210d configured to perform step S108, and a configure module 210e configured to perform step S110. The network node 200 of FIG. 9 may further comprise a number of optional functional modules, such as any of a configure module 210a configured to perform step S102, and a configure module 210b configured to perform step S104. In general terms, each functional module 210a: 210e may be implemented in hardware or in software. Preferably, one or more or all functional modules 210a: 210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210e and to execute these instructions, thereby performing any steps of the network node 200 as disclosed herein.

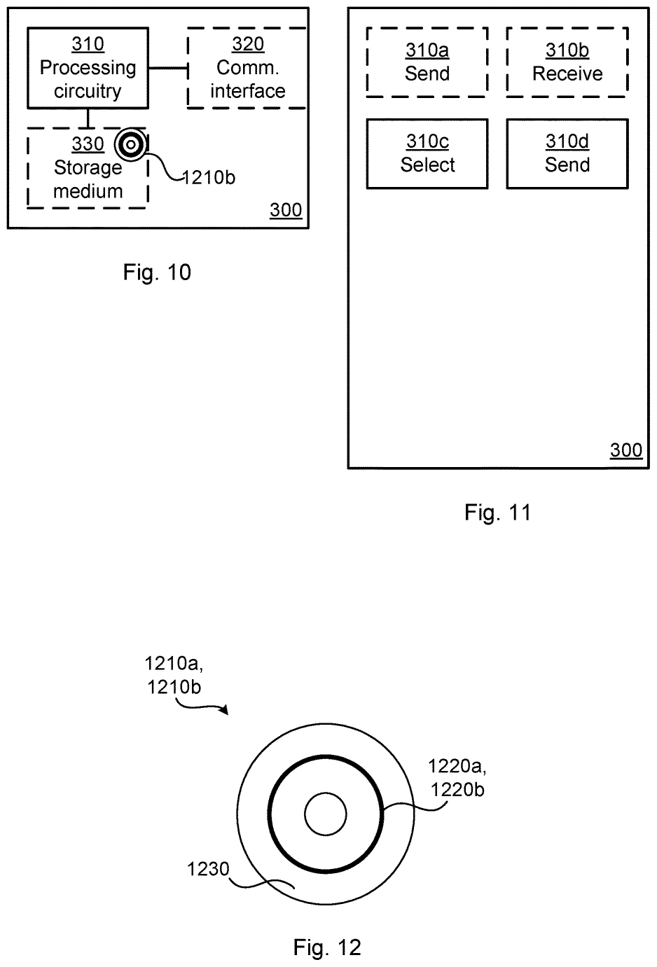

The network node 200 may be provided as a standalone device or as a part of at least one further device. For example, the network node 200 may be provided in a node of a (radio) access network or in a node of a core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210, 310 is illustrated in FIGS. 8 and 10 the processing circuitry 210, 310 may be distributed among a plurality of devices, or nodes. The same applies to the functional modules 210a: 210e of FIG. 9 and the computer program 1220a of FIG. 12.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 10 schematically illustrates, in terms of a number of functional units, the components of a UE 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1210b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the UE 300 to perform a set of operations, or steps, as disclosed above. For example, the storage medium 330 may store the set of operations, and the processing circuitry 310 may be configured to retrieve the set of operations from the storage medium 330 to cause the UE 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UE 300 may further comprise a communications interface 320 for communications with other entities, functions, nodes, and devices, either directly or indirectly, such as with the network node 200 via the RIS 400. As such the communications interface 320 may comprise one or more transmitters and receivers, comprising analogue and digital components.

The processing circuitry 310 controls the general operation of the UE 300 e.g. by sending data and control signals to the communications interface 320 and the storage medium 330, by receiving data and reports from the communications interface 320, and by retrieving data and instructions from the storage medium 330. Other components, as well as the related functionality, of the UE 300 are omitted in order not to obscure the concepts presented herein.

FIG. 11 schematically illustrates, in terms of a number of functional modules, the components of a UE 300 according to an embodiment. The UE 300 of FIG. 11 comprises a number of functional modules; a select module 310c configured to perform step S206, and a send module 310d configured to perform step S208. The UE 300 of FIG. 11 may further comprise a number of optional functional modules, such as any of a send module 310a configured to perform step S202, and a receive module 310b configured to perform step S204. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the UE 300 as disclosed herein.

FIG. 12 shows one example of a computer program product 1210a, 1210b comprising computer readable means 1230. On this computer readable means 1230, a computer program 1220a can be stored, which computer program 1220a can cause the processing circuitry 210 and thereto operatively coupled entities and devices, such as the communications interface 220 and the storage medium 230, to execute methods according to embodiments described herein. The computer program 1220a and/or computer program product 1210a may thus provide means for performing any steps of the network node 200 as herein disclosed. On this computer readable means 1230, a computer program 1220b can be stored, which computer program 1220b can cause the processing circuitry 310 and thereto operatively coupled entities and devices, such as the communications interface 320 and the storage medium 330, to execute methods according to embodiments described herein. The computer program 1220b and/or computer program product 1210b may thus provide means for performing any steps of the UE 300 as herein disclosed.

In the example of FIG. 12, the computer program product 1210a, 1210b is illustrated as an optical disc, such as a CD (compact disc) or a DVD (digital versatile disc) or a Blu-Ray disc. The computer program product 1210a, 1210b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1220a, 1220b is here schematically shown as a track on the depicted optical disk, the computer program 1220a, 1220b can be stored in any way which is suitable for the computer program product 1210a, 1210b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A network node for monostatic beam calibration for a link between the network node and a user equipment, (UE) via a reflective intelligent surface (RIS), wherein the network node is configured for communication in a first set of beams, the UE is configured for communication in a second set of beams, and the RIS is configured for communication in a set of reflection states as controllable by the network node, the network node comprising processing circuitry, the processing circuitry being configured to cause the network node to:
select a combination of one beam in the first set of beams and a first reflection state in the reflection states by performing monostatic beam calibration with the RIS for the link between the network node and the RIS for different combinations of beams in the first set of beams and reflection states in the set of reflection states;
receive a report of monostatic beam calibration as performed by the UE for the link between the UE and the RIS, wherein the report identifies a second reflection state in the reflection states; and
configure the RIS with a third reflection state as determined from a combination of the first reflection state and the second reflection state.

2. The network node of claim 1, wherein each of the reflection states represent a respective set of phase shift settings associated with individual elements of the RIS, and wherein the third reflection state is determined as a function of the set of phase shift settings for the first reflection state and the set of phase shift settings for the second reflection state.

3. The network node of claim 1, the processing circuitry being configured to cause the network node to:
configure the RIS with the set of reflection states and instructions to cycle through the set of reflection states in a time synchronized and time-sequential manner.

4. The network node of claim 1, the processing circuitry being configured to cause the network node to:
configure the UE to perform the monostatic beam calibration for the link between the UE and the RIS.

5. The network node of claim 1, wherein, according to the monostatic beam calibration, a sensing signal is transmitted by the network node for reflection by the RIS back to the network node for each combination of beams in the first set of beams and reflection states in the set of reflection states.

6. The network node of claim 1, wherein, according to the monostatic beam calibration, the different combinations of beams in the first set of beams and reflection states in the set of reflection states are cycled through in a time synchronized and time-sequential manner whilst the sensing signals are transmitted by the network node.

7. The network node of claim 1, wherein the combination of beam in the first set of beams and reflection state in the reflection states is selected that satisfies a performance metric for the sensing signals at the network node.

8. The network node of claim 1, wherein the UE is configured by the network node to select the second reflection state as the reflection state in the reflection states that satisfies a performance metric at the UE of sensing signals as transmitted by the UE and reflected by the RIS.

9. The network node of claim 1, wherein the network node comprises antenna elements, and wherein, during the monostatic beam calibration with the RIS, a first set of the antenna elements is used for transmission of the sensing signals and a second subset of the antenna elements is used for reception of the sensing signals.

10. The network node of claim 1, wherein the monostatic beam calibration with the RIS is performed responsive to the network node having obtained an indication of change in received signal quality in either downlink or uplink.

11. A user equipment (UE) for monostatic beam calibration for a link between the UE and a reflective intelligent surface (RIS), wherein the UE is configured for communication in a second set of beams with a network node via the RIS, and the RIS is configured for communication in a set of reflection states, the UE comprising processing circuitry, the processing circuitry being configured to cause the UE to:
select a combination of one beam in the second set of beams and a second reflection state in the reflection states by performing monostatic beam calibration with the RIS for the link between the UE and the RIS for different combinations of beams in the second set of beams and reflection states in the set of reflection states; and
send a report of the monostatic beam calibration towards the network node, wherein the report identifies the second reflection state.

12. The UE of claim 11, the processing circuitry being configured to cause the UE to:
receive configuration from the network node for the UE to perform the monostatic beam calibration for the link between the UE and the RIS.

13. The UE of claim 11, wherein, according to the monostatic beam calibration, a sensing signal is transmitted by the UE for reflection by the RIS back to the UE for each combination of beams in the second set of beams and reflection states in the set of reflection states.

14. The UE of claim 11, wherein, according to the monostatic beam calibration, the different combinations of beams in the second set of beams and reflection states in the set of reflection states are cycled through in a time synchronized and time-sequential manner whilst the sensing signals are transmitted by the UE.

15. The UE of claim 11, wherein the second reflection state satisfies a performance metric for the sensing signals at the UE.

16. The UE claim 11, wherein the UE comprises antenna elements, and wherein, during the monostatic beam calibration with the RIS, a first set of the antenna elements is used for transmission of the sensing signals and a second subset of the antenna elements is used for reception of the sensing signals.

17. The UE of claim 11, the processing circuitry being configured to cause the UE to:
send an indication to the network node responsive to the UE having obtained an indication of change of any of: received signal quality in downlink, rotation of the UE, and wherein the configuration from the network node for the UE to perform the monostatic beam calibration is received in response thereto.

18. (canceled)

19. A method for monostatic beam calibration for a link between a network node and a user equipment, (UE) via a reflective intelligent surface, (RIS), wherein the network node is configured for communication in a first set of beams, the UE is configured for communication in a second set of beams, and the RIS is configured for communication in a set of reflection states as controllable by the network node, the method being performed by the network node, the method comprising:
selecting a combination of one beam in the first set of beams and a first reflection state in the reflection states by performing monostatic beam calibration with the RIS for the link between the network node and the RIS for different combinations of beams in the first set of beams and reflection states in the set of reflection states;
receiving a report of monostatic beam calibration as performed by the UE for the link between the UE and the RIS, wherein the report identifies a second reflection state in the reflection states; and
configuring the RIS with a third reflection state as determined from a combination of the first reflection state and the second reflection state.

20. (canceled)

21. A method for monostatic beam calibration for a link between a user equipment (UE) and a reflective intelligent surface (RIS), wherein the UE is configured for communication in a second set of beams with a network node via the RIS, and the RIS is configured for communication in a set of reflection states, the method being performed by the UE, the method comprising:
selecting a combination of one beam in the second set of beams and a second reflection state in the reflection states by performing monostatic beam calibration with the RIS for the link between the UE and the RIS for different combinations of beams in the second set of beams and reflection states in the set of reflection states; and
sending a report of the monostatic beam calibration towards the network node, wherein the report identifies the second reflection state.

22-24. (canceled)
